(19) United States
(12) Patent Application Publication
(10) Pub. No.: US 2026/0128022 A1
(43) Pub. Date: May 7, 2026

(54) MUSIC DATA PROCESSING

(71) Applicants: Beijing Zitiao Network Technology Co., Ltd., Beijing (CN); Lemon Inc., Grand Cayman (KY)

(72) Inventors: Haonan Chen, Los Angeles, CA (US); Jordan BL Smith, London (GB); Janne Jayne Harm Renée Spijkervet, Los Angeles, CA (US); Ju-Chiang Wang, Los Angeles, CA (US); Pei Zou, Beijing (CN); Bochen Li, Los Angeles, CA (US); Qiuqiang Kong, Los Angeles, CA (US); Xingjian Du, Beijing (CN)

(21) Appl. No.: 18/936,796

(22) Filed: Nov. 4, 2024

(51) Int. Cl. G10H 1/00

(52) U.S. Cl. CPC G10H 1/0025; G10H 2210/031

(57) ABSTRACT

There are provided methods, devices, and computer program products for processing music data. In a method, the music data is divided into a plurality of segments according to a predetermined length. A plurality of control tokens are determined for the plurality of segments based on control information associated with the plurality of segments, respectively. A plurality of sound tokens are determined for the plurality of segments based on sound information associated with the plurality of segments, respectively. A feature for the music data is obtained based on the plurality of control tokens and the plurality of sound tokens.

### FIELD

The present disclosure generally relates to machine learning, and more specifically, to methods, devices and computer program products for processing music data.

### BACKGROUND

In the current technology of generating multi track music score, music score is usually converted into a token sequence first, then a model (usually based on a transformer) may be used to model the token sequence. Multi track music has correlations between the time dimension and different instrument track dimensions, but the token sequence is one-dimensional. How to design the encoding method of the token sequence to facilitate a model to learn this two-dimensional correlation is an issue. Furthermore, because the music score may be directly edited by composers, how to enable composers to control the generation of music score through some control signals is another issue.

### SUMMARY

In a first aspect of the present disclosure, there is provided a method for processing music data. In the method, the music data is divided into a plurality of segments according to a predetermined length. A plurality of control tokens are determined for the plurality of segments based on control information associated with the plurality of segments, respectively. A plurality of sound tokens are determined for the plurality of segments based on sound information associated with the plurality of segments, respectively. A feature for the music data is obtained based on the plurality of control tokens and the plurality of sound tokens.

In a second aspect of the present disclosure, there is provided an electronic device. The electronic device comprises: a computer processor coupled to a computer-readable memory unit, the memory unit comprising instructions that when executed by the computer processor implements a method according to the first aspect of the present disclosure.

In a third aspect of the present disclosure, there is provided a computer program product, the computer program product comprising a computer readable storage medium having program instructions embodied therewith, the program instructions executable by an electronic device to cause the electronic device to perform a method according to the first aspect of the present disclosure.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE SEVERAL VIEWS OF THE DRAWINGS

Through the more detailed description of some implementations of the present disclosure in the accompanying drawings, the above and other objects, features and advantages of the present disclosure will become more apparent, wherein the same reference generally refers to the same components in the implementations of the present disclosure.

FIG. 1 illustrates a schematic diagram of music data being encoded based on a related work;

FIG. 2 illustrates an example diagram of processing music data according to implementations of the present disclosure;

FIG. 3 illustrates a schematic diagram of combining control tokens and sound tokens according to implementations of the present disclosure;

FIG. 4 illustrates a schematic diagram of determining sound tokens according to implementations of the present disclosure;

FIG. 5 illustrates a schematic diagram of training a music generating model according to implementations of the present disclosure;

FIG. 6 illustrates a schematic diagram of determining a subsequent token according to implementations of the present disclosure;

FIG. 7 illustrates an example flowchart of a method for processing music data according to implementations of the present disclosure; and

FIG. 8 illustrates a block diagram of a computing device in which various implementations of the present disclosure can be implemented.

### DETAILED DESCRIPTION

Principle of the present disclosure will now be described with reference to some implementations. It is to be understood that these implementations are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one implementation,” “an implementation,” “an example implementation,” and the like indicate that the implementation described may include a particular feature, structure, or characteristic, but it is not necessary that every implementation includes the particular feature, structure, or characteristic. Moreover, such phrases are not necessarily referring to the same implementation. Further, when a particular feature, structure, or characteristic is described in connection with an example implementation, it is submitted that it is within the knowledge of one skilled in the art to affect such feature, structure, or characteristic in connection with other implementations whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example implementations. As used herein, the term “and/or” includes any and all combinations of one or more of the listed terms.

The terminology used herein is for the purpose of describing particular implementations only and is not intended to be limiting of example implementations. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

Principle of the present disclosure will now be described with reference to some implementations. It is to be understood that these implementations are described only for the purpose of illustration and help those skilled in the art to understand and implement the present disclosure, without suggesting any limitation as to the scope of the disclosure. The disclosure described herein can be implemented in various manners other than the ones described below. In the following description and claims, unless defined otherwise, all technical and scientific terms used herein have the same meaning as commonly understood by one of ordinary skills in the art to which this disclosure belongs.

It may be understood that data involved in the present technical solution (including but not limited to the data itself, the acquisition or use of the data) should comply with requirements of corresponding laws and regulations and relevant rules.

It may be understood that, before using the technical solutions disclosed in various implementation of the present disclosure, the user should be informed of the type, scope of use, and use scenario of the personal information involved in the present disclosure in an appropriate manner in accordance with relevant laws and regulations, and the user's authorization should be obtained.

For example, in response to receiving an active request from the user, prompt information is sent to the user to explicitly inform the user that the requested operation will need to acquire and use the user's personal information. Therefore, the user may independently choose, according to the prompt information, whether to provide the personal information to software or hardware such as electronic devices, applications, servers, or storage media that perform operations of the technical solutions of the present disclosure.

As an optional but non-limiting implementation, in response to receiving an active request from the user, the way of sending prompt information to the user, for example, may include a pop-up window, and the prompt information may be presented in the form of text in the pop-up window. In addition, the pop-up window may also carry a selection control for the user to choose “agree” or “disagree” to provide the personal information to the electronic device.

It may be understood that the above process of notifying and obtaining the user authorization is only illustrative and does not limit the implementation of the present disclosure. Other methods that satisfy relevant laws and regulations are also applicable to the implementation of the present disclosure.

As briefly mentioned above, the current technology of generating multi track music score faces some challenges. Some related works may be introduced in the following. In a related work, an encoding method of the token sequence is proposed. In the encoding method, all notes of one track of a song are encoded, and then the next track is encoded, and so on. However, for songs that are too long, the length of individual instrument tracks may also be too long, which causes notes at the same position on different tracks to be too far apart and makes it difficult for the model to learn their correlations.

In a related work, a sequence-to-sequence model is used. Control signals are treated as a separate sequence input and the output is the music score. However, control signals are mandatory inputs, and without complete control signals, it is impossible to generate a music score, which is not flexible enough.

In a related work, compound tokens are used, that is, a token contains a plurality of information about a musical note. This can shorten the total length of the sequence and facilitate model learning. However, the encoding method of compound tokens has a lot of information redundancy, for example, notes in the same section need to be repeated with the section index during encoding. Furthermore, only limited control may be exercised over the information present in the compound tokens.

In a related work, a masked language model objective of bidirectional encoder representations from transformers may be used and compound tokens are also used. However, the training method of masked language model cannot directly generate the music score and can only perform tasks such as melody completion and accompaniment generation based on the existing music score. As can be seen from above, these related works have significant limitations in terms of controllability.

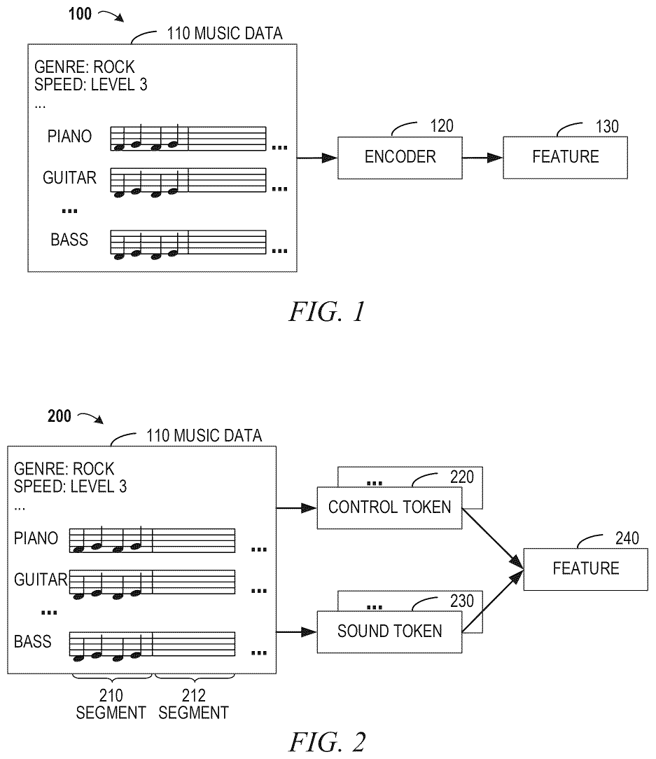

FIG. 1 illustrates a schematic diagram 100 of music data being encoded based on a related work. As shown in FIG. 1, music data 110 includes information about genre, speed, instrument tracks (e.g., piano, guitar, bass) and the like. The music data 110 is encoded, using an encoder 120, to obtain a feature 130. The encoder 120 may employ any encoding scheme described in the above related works. However, there are correlations in the time dimension and different instrument track dimensions in the music data 110. Encoding the music data 110 as a whole, the feature 130 may not capture various aspects of information in the music data 110 well.

In view of the above, the present disclosure proposes a solution for processing music data with reference to FIG. 2, which illustrates an example diagram 200 of processing music data according to implementations of the present disclosure. As illustrated in FIG. 2, the music data 110 is divided into a plurality of segments (e.g., segment 210 and segment 212, . . . ) according to a predetermined length. A plurality of control tokens (e.g., control token 220, . . . ) are determined for the plurality of segments based on control information associated with the plurality of segments, respectively. A plurality of sound tokens (e.g., sound token 230, . . . ) are determined for the plurality of segments based on sound information associated with the plurality of segments, respectively. A feature 240 for the music data is obtained based on the plurality of control tokens and the plurality of sound tokens.

With these implementations of the present disclosure, the music data is encoded based on a combination of the control information and the sound information to obtain the feature. In this way, the feature may capture various aspects of information in the music data and relationships between them, which may be beneficial to a model used for generating music based on the feature. Specifically, the control tokens includes the control information for the whole music data, and the sound tokens includes the sound information of multiple tracks at various time points, and then the feature may provide rich information for the downstream task.

In some implementations, the music data 110 may include music score. The control information may include a genre, a section, a speed, a chord, and a track of the music data. The sound information may include a position, a duration, a pitch of a musical note. The plurality of segments may be a plurality of bars in the music score. The plurality of control tokens 220 and the plurality of sound tokens 230 may be combined in any way. In some examples, one control token may be followed by a sound token, alternatively, all control tokens may be followed by all sound tokens.

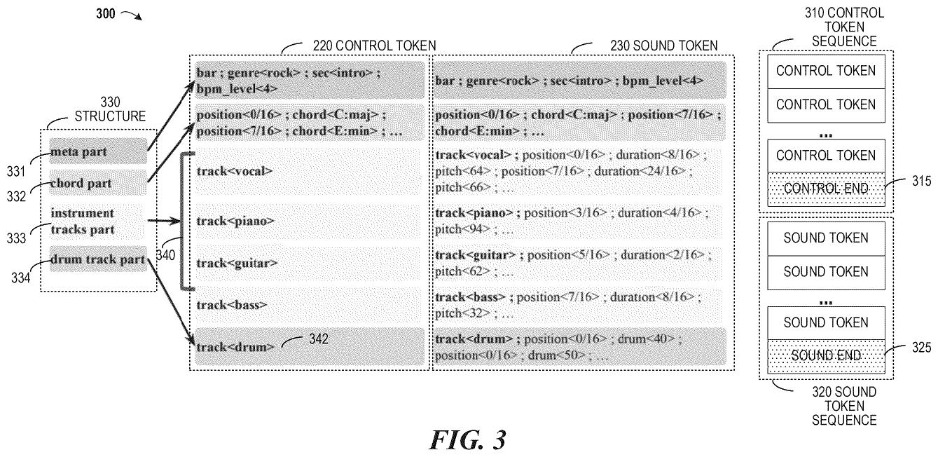

In implementations of the present disclosure, with respect to a segment in the plurality of segments, a control item may be extracted from the segment and the control item comprises at least any of: a genre, a section, a speed, a chord, and a track of the music data. The following will describe determining control tokens with reference to FIG. 3, which illustrates a schematic diagram 300 of combining control tokens and sound tokens according to implementations of the present disclosure. As shown in FIG. 3, the control token 220 may be arranged according to a structure 330 of the music data 110. The structure 330 includes at least one of a meta part 331, a chord part 332, an instrument tracks part 333 and a drum track part 334. In addition, tracks in the control token 220 may be arranged according to a predetermined order and musical notes in the tracks may be arranged in chronological order. Instead of input as a separate token sequence, control signals (also referred to as control items) in the segment in the music score may be directly encoded. The control signals may include bar token, genre token, section token, beat per minute (BPM) level token, chord token and its corresponding position token, instrument track and drum track token, and the like. Then, a control token for the segment may be determined based on the control item. In this way, control signals may be encoded as a part of the feature and then a model used for generating music may generate control signals by itself, and thus the flexibility of providing control signals may be enhanced.

In implementations of the present disclosure, the music data 110 may include at least one track, such as instrument track (e.g., vocal track, piano track, guitar track and bass track) and drum track. With respect to a track in the at least one track within the segment, a track part (e.g., the instrument track part 340 or the drum track part 342) may be generated for the track. Furthermore, the track part may be inserted into the control token 220 for the segment.

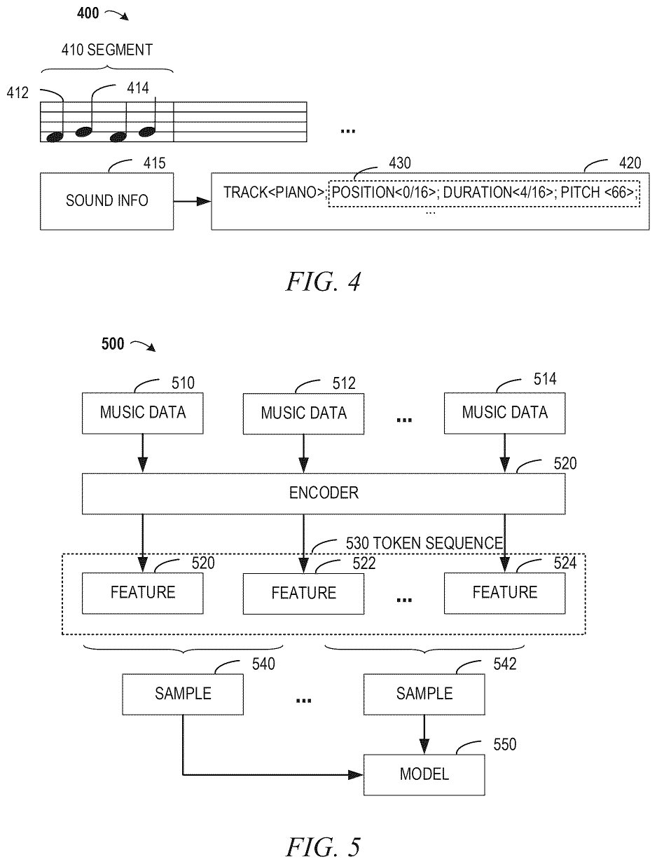

In implementations of the present disclosure, a sound token for the segment may be determined by updating the control token for the segment with the sound information associated with the segment. The following will describe determining sound tokens with reference to FIG. 4, which illustrates a schematic diagram 400 of determining sound tokens according to implementations of the present disclosure. As shown in FIG. 4, the sound information 415 associated with the segment 410 is inserted into a track part 420 (as an example of the piano track) of the control token 220 for the segment 410 to update the control token 220. Then, the sound token 230 for the segment may be determined based on the updated control token. In this way, the sound token may be easily generated based on a structure of the control token and a content of the sound information.

In implementations of the present disclosure, a sound item may be extracted from the sound information associated with the segment. The sound item may include at least any of: a position, a duration, and a pitch of a musical note in the segment. The sound token for the segment may be determined by updating the track part in the control token for the segment with the sound item. In some examples, the musical note may include a whole note, a half note, a quarter note, an eighth note, a sixteenth note and the like. In the example of FIG. 4, the sound item 430 may include the position, duration and pitch of the musical note 412 (as an example of the quarter note) in the segment 410. It is to be noted that the sound item 430 being inserted in the track part 420 is merely an example and other sound items may also be used to determine the sound token. Musical nots in the segment 410 may be processed one by one, for example, the musical note 414 may be processed in a similar way and a sound item for the musical not 414 may be generated and appended to the track part 420 after the sound item 430.

In some implementations, in a case where the track part in the control token to be updated is a drum track, the sound item used to update the track part may include a position and a drum of a musical note.

After the plurality of control tokens and the plurality of sound tokens are determined, they may be combined to obtain the feature 130. Returning to FIG. 3, in implementations of the present disclosure, a control token sequence 310 may be determined based on the plurality of control tokens (including at least the control token 220) and the control token sequence 310 may have a control sequence end 315. The control sequence end 315 may indicate all control tokens have been encoded. A sound token sequence 320 may be determined based on the plurality of sound tokens (including at least the sound token 230) and the sound token sequence 320 may have a sound sequence end 325. The sound sequence end 325 may indicate all sound tokens have been encoded. Then, the feature 240 may be determined based on a concatenation of the control token sequence 315 and the sound token sequence 320. With these embodiments, the control information is provided at the first part of the feature. In this way, the information of the music data may be comprehensively grasped by a model used for generating music and the impact of the control information may be enhanced.

The following will introduce training a music generating model at least based on reference features with reference to FIG. 5, which illustrates a schematic diagram 500 of training a music generating model according to implementations of the present disclosure. As shown in FIG. 5, in implementations of the present disclosure, in response to receiving a plurality of reference music data (e.g., music data 510, music data 512, music data 514, etc.), a plurality of reference features (e.g., reference feature 520, reference feature 522, reference feature 524, etc.) may be determined. The plurality of reference features may be determined by an encoder 520. The plurality of reference features may be combined into a reference feature sequence (e.g., the token sequence 530). A training sample (e.g., sample 540, sample 542, etc.) may be obtained from the reference feature sequence according to a predetermined window size.

In an example, the training sample may be obtained randomly, and the predetermined window size may be 10240 (or have a different value). After the training sample is obtained, the music generating model (e.g., the model 550) may be trained based on the training sample. The music generating model may represent an association relationship between at least one reference previous token and a reference subsequent token that follows the at least one reference previous token. The music generating model may be a language model. With these implementations, during the process of training the music generating model, the control sequence end and the sound sequence end may be used to distinguish the end of the control information and the end of the sound information. In this way, the model may distinguish the internal parts of each music data, and situations where the training samples are too long or too short may be avoided. Furthermore, by obtaining training sample randomly, the trained model may be able to generate subsequent tokens based on any length of previous token from any position, thereby improving the generating ability of the model.

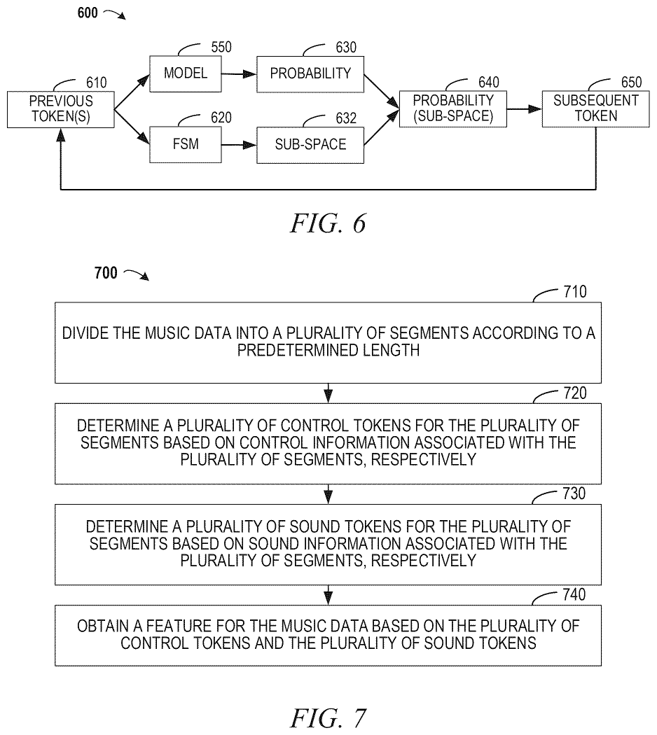

The following will introduce determining a subsequent token using the music generating model with reference to FIG. 6, which illustrates a schematic diagram 600 of determining a subsequent token according to implementations of the present disclosure. As shown in FIG. 6, in implementations of the present disclosure, a first probability 630 of a subsequent token 650 may be determined according to the music generating model (e.g., the model 550) based on at least one previous token 610. Furthermore, the subsequent token 650 may be determined based on the first probability 630. At the first round of determining the subsequent token, the previous token may be a token indicating “NULL”. In some examples, the first probability 630 may be a probability distribution over a token space and the probability distribution may be converted by performing a normalization operation on a logits matrix.

In implementations of the present disclosure, the subsequent token 650 may be determined based on the first probability 630 and a sub-space. After the first probability 630 is determined, a sub-space 632 in a token space of the subsequent token 650 may be determined according to a Finite State Machine (FSM) based on the at least one previous token 610. The subsequent token 650 may be determined based on the first probability 630 of the subsequent token and the sub-space 632. In an example, the subsequent token 650 may be sampled from the sub-space 632 based on the first probability 630. With the FSM, it ensures that the syntax of the token sequence is correct. Further, the user's control information may be inputted into the model through FSM by the subspace sampling. For example, if a user wishes to generate rock music, the token in the subspace corresponding to the rock music may be selected when determining subsequent token, and thus the token sequence may have a rock style.

In implementations of the present disclosure, a second probability 640 associated with the first probability 630 and the sub-space 632 may be determined. The subsequent token 650 may be determined based on the second probability 640. In an example, the first probability 630 may be in the form of a logits matrix and elements corresponding to the sub-space 632 may be extracted from the logits matrix to form a sub logits matrix. The sub logits matrix may be normalized to obtain a probability distribution (as an example of the second probability 640). Then, a token with the highest probability may be sampled from the probability distribution.

In implementations of the present disclosure, in response to a determination that the subsequent token 650 is an end token, target music data may be generated based on the at least one previous token 610. In response to a determination that the subsequent token 650 is not an end token, the subsequent token 650 may be appended to an end of the at least one previous token 610. Then, the at least one previous token 610 after being appended may be input to the music generating model to generate subsequent token 650. With these implementations, the token sequence before the end token may correspond to a new music score. For example, the token sequence may be decoded into the new music score that may be read by the musician.

The above paragraphs have described details for processing music data. According to implementations of the present disclosure, a method is provided for processing music data. Reference will be made to FIG. 7 for more details about the method, where FIG. 7 illustrates an example flowchart of a method 700 for processing music data according to implementations of the present disclosure. At block 710, the music data is divided into a plurality of segments according to a predetermined length. At block 720, a plurality of control tokens are determined for the plurality of segments based on control information associated with the plurality of segments, respectively. At block 730, a plurality of sound tokens are determined for the plurality of segments based on sound information associated with the plurality of segments, respectively. At block 740, a feature for the music data is obtained based on the plurality of control tokens and the plurality of sound tokens.

In implementations of the present disclosure, determining a control token sequence based on the plurality of control tokens, the control token sequence having a control sequence end; determining a sound token sequence based on the plurality of sound tokens, the sound token sequence having a sound sequence end; and determining the feature based on the control token sequence and the sound token sequence.

In implementations of the present disclosure, determining the plurality of control tokens based on the control information associated with the plurality of segments comprises: with respect to a segment in the plurality of segments, extracting a control item from the segment, the control item comprising at least any of: a genre, a section, a speed, a chord, and a track of the music data; and determining a control token for the segment based on the control item.

In implementations of the present disclosure, the music data comprises at least one track, and determining the control token comprises: with respect to a track in the at least one track within the segment, generating a track part for the track; and inserting the track part into the control token for the segment.

In implementations of the present disclosure, determining the plurality of sound tokens based on the sound information associated with the plurality of segments comprises: determining a sound token for the segment by updating the control token for the segment with the sound information associated with the segment.

In implementations of the present disclosure, determining the sound token for the segment comprises: extracting a sound item from the sound information associated with the segment, the sound item comprising at least any of: a position, a duration, and a pitch of a musical note in the segment; and determining the sound token for the segment by updating the track part in the control token for the segment with the sound item.

In implementations of the present disclosure, the method 700 further comprising: in response to receiving a plurality of reference music data, determining a plurality of reference features; combining the plurality of reference features into a reference feature sequence; obtaining a training sample from the reference feature sequence according to a predetermined window size; and training a music generating model based on the training sample, the music generating model representing an association relationship between at least one reference previous token and a reference subsequent token that follows the at least one reference previous token.

In implementations of the present disclosure, the method 700 further comprising: determining a first probability of a subsequent token according to the music generating model based on at least one previous token; determining a sub-space in a token space of the subsequent token according to a finite state machine based on the at least one previous token; and determining the subsequent token based on the first probability of the subsequent token and the sub-space.

In implementations of the present disclosure, determining the subsequent token comprises: determining a second probability associated with the first probability and the sub-space; and determining the subsequent token based on the second probability.

In implementations of the present disclosure, the method 700 further comprising any of: in response to a determination that the subsequent token is an end token, generating target music data based on the at least one previous token; or in response to a determination that the subsequent token is not an end token, appending the subsequent token to an end of the at least one previous token.

According to implementations of the present disclosure, an apparatus is provided for processing music data. The apparatus comprises: a music data dividing module configured for dividing the music data into a plurality of segments according to a predetermined length; a control token determining module configured for determining a plurality of control tokens for the plurality of segments based on control information associated with the plurality of segments, respectively; a sound token determining module configured for determining a plurality of sound tokens for the plurality of segments based on sound information associated with the plurality of segments, respectively; and a feature obtaining module configured for obtaining a feature for the music data based on the plurality of control tokens and the plurality of sound tokens.

According to implementations of the present disclosure, an electronic device is provided for implementing the method 700. The electronic device comprises: a computer processor coupled to a computer-readable memory unit, the memory unit comprising instructions that when executed by the computer processor implements a method for data classification. The method comprises: obtaining a sample for training a machine learning model, the sample comprising a prompt and a response for the prompt, the prompt comprising input data, and the response comprising a classification of the input data, and a reason why the input data belongs to the classification; determining a first sample based on the input data and the classification of the input data, the first sample comprising a first prompt and a first response; determining a second sample based on the input data, the classification of the input data, and the reason, the second sample comprising a second prompt and a second response; and updating the machine learning model based on the first and the second samples.

In implementations of the present disclosure, the machine learning model implements a task for outputting a classification of target data and a response why the target data belongs to the classification, and determining the first and second samples comprises: dividing the task into a first task and a second task that is implemented after the first task, the first task outputting a classification of the target data, and the second task outputting a response why the target data belongs to the classification; obtaining the first sample, according to the first task, based on the input data and the classification of the input data; and obtaining the second sample, according to the second task, based on the input data, the classification of the input data, and the reason.

In implementations of the present disclosure, obtaining the first sample comprises: obtaining a first template corresponding to the first task, the first template being represented in a natural language format, and comprising a first position for inserting the input data and a second position for inserting the classification; and obtaining the first sample by updating the first template with the input data and the classification of the input data.

In implementations of the present disclosure, obtaining the first sample by updating the first template with the input data and the classification of the input data comprises: obtaining the first prompt in the first sample by updating a prompt portion in the first template with the input data; and obtaining the first response in the first sample by updating a response portion in the first template with the classification.

In implementations of the present disclosure, obtaining the first prompt comprises: adding a plurality of candidate classifications of the input data into the first prompt based on a length limit for the first prompt.

In implementations of the present disclosure, obtaining the second sample comprises: obtaining a second template corresponding to the second task, the second template being represented in a natural language format, and comprising a third position for inserting the input data, a fourth position for inserting the classification, and a fifth position for inserting the reason; and obtaining the second sample by updating the second template with the input data, the classification of the input data, and the reason.

In implementations of the present disclosure, obtaining the second sample by updating the second template with the input data, the classification of the input data, and the reason comprises: obtaining the second prompt in the second sample by updating a prompt portion in the second template with the input data and classification; and obtaining the second response in the second sample by updating a response portion in the second template with the reason.

In implementations of the present disclosure, the method 700 further comprises: determining a ratio between a first number of a first plurality of first samples and a second number of a second plurality of second samples based on a purpose of the machine learning model; and obtaining the first plurality of first samples and the second plurality of second samples based on the ratio.

In implementations of the present disclosure, updating the machine learning model based on the first and the second samples comprises: selecting a batch of samples from the first plurality of first samples and the second plurality of second samples based on a predetermined batch number; and updating the machine learning model based on the batch of samples.

In implementations of the present disclosure, the method 700 further comprises: in response to receiving a target prompt that comprising target input data, providing, by the machine learning model, a target classification of the target input data, and a reason why the target input data belongs to the target classification.

According to implementations of the present disclosure, a computer program product is provided, the computer program product comprising a computer readable storage medium having program instructions embodied therewith, the program instructions executable by an electronic device to cause the electronic device to perform the method 700.

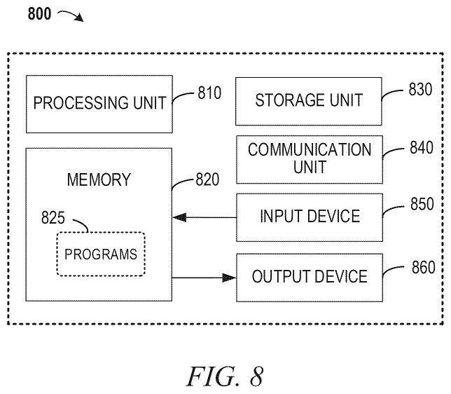

FIG. 8 illustrates a block diagram of a computing device 800 in which various implementations of the present disclosure can be implemented. It would be appreciated that the computing device 800 shown in FIG. 8 is merely for purpose of illustration, without suggesting any limitation to the functions and scopes of the present disclosure in any manner. The computing device 800 may be used to implement the above method 700 in implementations of the present disclosure. As shown in FIG. 8, the computing device 800 may be a general-purpose computing device. The computing device 800 may at least comprise one or more processors or processing units 810, a memory 820, a storage unit 830, one or more communication units 840, one or more input devices 850, and one or more output devices 860.

The processing unit 810 may be a physical or virtual processor and can implement various processes based on programs 825 stored in the memory 820. In a multi-processor system, multiple processing units execute computer executable instructions in parallel so as to improve the parallel processing capability of the computing device 800. The processing unit 810 may also be referred to as a central processing unit (CPU), a microprocessor, a controller, or a microcontroller.

The computing device 800 typically includes various computer storage medium. Such medium can be any medium accessible by the computing device 800, including, but not limited to, volatile and non-volatile medium, or detachable and non-detachable medium. The memory 820 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 830 may be any detachable or non-detachable medium and may include a machine-readable medium such as a memory, flash memory drive, magnetic disk, or another other media, which can be used for storing information and/or data and can be accessed in the computing device 800.

The computing device 800 may further include additional detachable/non-detachable, volatile/non-volatile memory medium. Although not shown in FIG. 8, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 840 communicates with a further computing device via the communication medium. In addition, the functions of the components in the computing device 800 can be implemented by a single computing cluster or multiple computing machines that can communicate via communication connections. Therefore, the computing device 800 can operate in a networked environment using a logical connection with one or more other servers, networked personal computers (PCs) or further general network nodes.

The input device 850 may be one or more of a variety of input devices, such as a mouse, keyboard, tracking ball, voice-input device, and the like. The output device 860 may be one or more of a variety of output devices, such as a display, loudspeaker, printer, and the like. By means of the communication unit 840, the computing device 800 can further communicate with one or more external devices (not shown) such as the storage devices and display device, with one or more devices enabling the user to interact with the computing device 800, or any devices (such as a network card, a modem, and the like) enabling the computing device 800 to communicate with one or more other computing devices, if required. Such communication can be performed via input/output (I/O) interfaces (not shown).

In some implementations, instead of being integrated in a single device, some, or all components of the computing device 800 may also be arranged in cloud computing architecture. In the cloud computing architecture, the components may be provided remotely and work together to implement the functionalities described in the present disclosure. In some implementations, cloud computing provides computing, software, data access and storage service, which will not require end users to be aware of the physical locations or configurations of the systems or hardware providing these services. In various implementations, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The functionalities described herein can be performed, at least in part, by one or more hardware logic components. For example, and without limitation, illustrative types of hardware logic components that can be used include Field-Programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

Program code for carrying out the methods of the subject matter described herein may be written in any combination of one or more programming languages. The program code may be provided to a processor or controller of a general-purpose computer, special purpose computer, or other programmable data processing apparatus such that the program code, when executed by the processor or controller, causes the functions/operations specified in the flowcharts and/or block diagrams to be implemented. The program code may be executed entirely or partly on a machine, executed as a stand-alone software package partly on the machine, partly on a remote machine, or entirely on the remote machine or server.

In the context of this disclosure, a machine-readable medium may be any tangible medium that may contain or store a program for use by or in connection with an instruction execution system, apparatus, or device. The machine-readable medium may be a machine-readable signal medium or a machine-readable storage medium. A machine-readable medium may include but not limited to an electronic, magnetic, optical, electromagnetic, infrared, or semiconductor system, apparatus, or device, or any suitable combination of the foregoing. More specific examples of the machine-readable storage medium would include an electrical connection having one or more wires, a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are illustrated in a particular order, this should not be understood as requiring that such operations are performed in the particular order shown or in sequential order, or that all illustrated operations are performed to achieve the desired results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular implementations. Certain features that are described in the context of separate implementations may also be implemented in combination in a single implementation. Rather, various features described in a single implementation may also be implemented in multiple implementations separately or in any suitable sub-combination.

Although the subject matter has been described in language specific to structural features and/or methodological acts, it is to be understood that the subject matter specified in the appended claims is not necessarily limited to the specific features or acts described above. Rather, the specific features and acts described above are disclosed as example forms of implementing the claims.

From the foregoing, it will be appreciated that specific implementations of the presently disclosed technology have been described herein for purposes of illustration, but that various modifications may be made without deviating from the scope of the disclosure. Accordingly, the presently disclosed technology is not limited except as by the appended claims.

Implementations of the subject matter and the functional operations described in the present disclosure can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media, and memory devices, including by way of example semiconductor memory devices, e.g., EPROM, EEPROM, and flash memory devices. The processor and the memory can be supplemented by, or incorporated in, special purpose logic circuitry.

It is intended that the specification, together with the drawings, be considered exemplary only, where exemplary means an example. As used herein, the use of “or” is intended to include “and/or”, unless the context clearly indicates otherwise.

While the present disclosure contains many specifics, these should not be construed as limitations on the scope of any disclosure or of what may be claimed, but rather as descriptions of features that may be specific to particular implementations of particular disclosures. Certain features that are described in the present disclosure in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are illustrated in the drawings in a particular order, this should not be understood as requiring that such operations be performed in the particular order shown or in sequential order, or that all illustrated operations be performed, to achieve desirable results. Moreover, the separation of various system components in the implementations described in the present disclosure should not be understood as requiring such separation in all implementations. Only a few implementations and examples are described and other implementations, enhancements and variations can be made based on what is described and illustrated in the present disclosure.

What is claimed is:

1. A method for processing music data, comprising:
dividing the music data into a plurality of segments according to a predetermined length;
determining a plurality of control tokens for the plurality of segments based on control information associated with the plurality of segments, respectively;
determining a plurality of sound tokens for the plurality of segments based on sound information associated with the plurality of segments, respectively; and
obtaining a feature for the music data based on the plurality of control tokens and the plurality of sound tokens.

2. The method of claim 1, wherein obtaining the feature based on the plurality of control tokens and the plurality of sound tokens comprises:
determining a control token sequence based on the plurality of control tokens, the control token sequence having a control sequence end;
determining a sound token sequence based on the plurality of sound tokens, the sound token sequence having a sound sequence end; and
determining the feature based on the control token sequence and the sound token sequence.

3. The method of claim 1, wherein determining the plurality of control tokens based on the control information associated with the plurality of segments comprises: with respect to a segment in the plurality of segments,
extracting a control item from the segment, the control item comprising at least any of: a genre, a section, a speed, a chord, and a track of the music data; and
determining a control token for the segment based on the control item.

4. The method of claim 3, wherein the music data comprises at least one track, and determining the control token comprises:
with respect to a track in the at least one track within the segment, generating a track part for the track; and
inserting the track part into the control token for the segment.

5. The method of claim 4, wherein determining the plurality of sound tokens based on the sound information associated with the plurality of segments comprises: determining a sound token for the segment by updating the control token for the segment with the sound information associated with the segment.

6. The method of claim 5, wherein determining the sound token for the segment comprises:
extracting a sound item from the sound information associated with the segment, the sound item comprising at least any of: a position, a duration, and a pitch of a musical note in the segment; and
determining the sound token for the segment by updating the track part in the control token for the segment with the sound item.

7. The method of claim 1, further comprising:
in response to receiving a plurality of reference music data, determining a plurality of reference features;
combining the plurality of reference features into a reference feature sequence;
obtaining a training sample from the reference feature sequence according to a predetermined window size; and
training a music generating model based on the training sample, the music generating model representing an association relationship between at least one reference previous token and a reference subsequent token that follows the at least one reference previous token.

8. The method of claim 7, further comprising:
determining a first probability of a subsequent token according to the music generating model based on at least one previous token;
determining a sub-space in a token space of the subsequent token according to a finite state machine based on the at least one previous token; and
determining the subsequent token based on the first probability of the subsequent token and the sub-space.

9. The method of claim 8, wherein determining the subsequent token comprises:
determining a second probability associated with the first probability and the sub-space; and
determining the subsequent token based on the second probability.

10. The method of claim 8, further comprising any of:
in response to a determination that the subsequent token is an end token, generating target music data based on the at least one previous token; or
in response to a determination that the subsequent token is not an end token, appending the subsequent token to an end of the at least one previous token.

11. An electronic device, comprising a computer processor coupled to a computer-readable memory unit, the memory unit comprising instructions that when executed by the computer processor implements a method for processing music data, the method comprises:
dividing the music data into a plurality of segments according to a predetermined length;
determining a plurality of control tokens for the plurality of segments based on control information associated with the plurality of segments, respectively;
determining a plurality of sound tokens for the plurality of segments based on sound information associated with the plurality of segments, respectively; and
obtaining a feature for the music data based on the plurality of control tokens and the plurality of sound tokens.

12. The electronic device of claim 11, wherein obtaining the feature based on the plurality of control tokens and the plurality of sound tokens comprises:
determining a control token sequence based on the plurality of control tokens, the control token sequence having a control sequence end;
determining a sound token sequence based on the plurality of sound tokens, the sound token sequence having a sound sequence end; and
determining the feature based on the control token sequence and the sound token sequence.

13. The electronic device of claim 11, wherein determining the plurality of control tokens based on the control information associated with the plurality of segments comprises: with respect to a segment in the plurality of segments,
extracting a control item from the segment, the control item comprising at least any of: a genre, a section, a speed, a chord, and a track of the music data; and
determining a control token for the segment based on the control item.

14. The electronic device of claim 13, wherein the music data comprises at least one track, and determining the control token comprises:
with respect to a track in the at least one track within the segment, generating a track part for the track; and
inserting the track part into the control token for the segment.

15. The electronic device of claim 14, wherein determining the plurality of sound tokens based on the sound information associated with the plurality of segments comprises: determining a sound token for the segment by updating the control token for the segment with the sound information associated with the segment.

16. The electronic device of claim 15, wherein determining the sound token for the segment comprises:
extracting a sound item from the sound information associated with the segment, the sound item comprising at least any of: a position, a duration, and a pitch of a musical note in the segment; and
determining the sound token for the segment by updating the track part in the control token for the segment with the sound item.

17. The electronic device of claim 11, the method further comprising:
in response to receiving a plurality of reference music data, determining a plurality of reference features;
combining the plurality of reference features into a reference feature sequence;
obtaining a training sample from the reference feature sequence according to a predetermined window size; and
training a music generating model based on the training sample, the music generating model representing an association relationship between at least one reference previous token and a reference subsequent token that follows the at least one reference previous token.

18. The electronic device of claim 17, the method further comprising:
determining a first probability of a subsequent token according to the music generating model based on at least one previous token;
determining a sub-space in a token space of the subsequent token according to a finite state machine based on the at least one previous token; and
determining the subsequent token based on the first probability of the subsequent token and the sub-space.

19. The electronic device of claim 18, wherein further comprising any of:
in response to a determination that the subsequent token is an end token, generating target music data based on the at least one previous token; or
in response to a determination that the subsequent token is not an end token, appending the subsequent token to an end of the at least one previous token.

20. A non-transitory computer program product, the computer program product comprising a computer readable storage medium having program instructions embodied therewith, the program instructions executable by an electronic device to cause the electronic device to perform a method for processing music data, the method comprises:
dividing the music data into a plurality of segments according to a predetermined length;
determining a plurality of control tokens for the plurality of segments based on control information associated with the plurality of segments, respectively;
determining a plurality of sound tokens for the plurality of segments based on sound information associated with the plurality of segments, respectively; and
obtaining a feature for the music data based on the plurality of control tokens and the plurality of sound tokens.
